(19) United States
(12) Patent Application Publication
(10) Pub. No.: US 2026/0268146 A1
(43) Pub. Date: Sep. 10, 2026

(54) METHOD AND PROCESSOR FOR PERFORMING LAYER FUSION IN NEURAL NETWORK

(71) Applicant: SAMSUNG ELECTRONICS CO., LTD., Suwon-si (KR)

(72) Inventors: Jungwoo CHOI, Suwon-si (KR); Woohyun JOO, Suwon-si (KR); Minseong KIM, Suwon-si (KR); Kihyoun KWON, Suwon-si (KR)

(73) Assignee: SAMSUNG ELECTRONICS CO., LTD., Suwon-si (KR)

(21) Appl. No.: 19/560,734

(22) Filed: Mar. 9, 2026

(30) Foreign Application Priority Data
Mar. 10, 2025 (KR) 10-2025-0030895
Jul. 7, 2025 (KR) 10-2025-0091164

(51) Int. Cl. G06N 3/082

(52) U.S. Cl. CPC G06N 3/082

(57) ABSTRACT

A method of performing layer fusion on a plurality of layers, included in a neural network for execution on hardware, includes receiving an operation graph including a plurality of residual blocks and corresponding to the neural network, determining an outermost merge layer included in each of the plurality of residual blocks, determining at least one fusion receiving layer from among a plurality of outermost merge layers of the plurality of residual blocks, determining a first fused layer group including a plurality of fused layers positioned in a previous path of the at least one fusion receiving layer, and generating a fused execution graph corresponding to a first single on-chip operation unit by performing the layer fusion on the plurality of fused layers.

### CROSS-REFERENCE TO RELATED APPLICATIONS

This application claims priority under 35 U.S.C. § 119 to Korean Patent Application No. 10-2025-0030895, filed on Mar. 10, 2025, and to Korean Patent Application No. 10-2025-0091164, filed on Jul. 7, 2025, in the Korean Intellectual Property Office, the disclosures of which are incorporated by reference herein in their entireties.

### BACKGROUND

### 1. Field

The present disclosure relates generally to neural networks, and more particularly, to a device and a method of performing layer fusion in a neural network.

### 2. Description of Related Art

Neural networks and/or artificial neural networks may be employed in various applications. Neural networks may need to perform a significant amount of matrix operations, and accordingly, dedicated hardware designed to implement the neural networks may be employed. Attempts to provide effective execution of a neural network on hardware, layer fusion may be performed on a plurality of layers included in the neural network, and the layer-fused operation units may be sequentially processed by the hardware. Performance of neural network processing by hardware may depend on the layer fusion of the neural network, and accordingly, efficient layer fusion may be needed.

### SUMMARY

One or more example embodiments of the present disclosure provide a device and method of efficiently providing optimal neural network layer fusion, when compared to related neural networks.

According to an aspect of the present disclosure, a method of performing layer fusion on a plurality of layers, included in a neural network for execution on hardware, includes receiving an operation graph including a plurality of residual blocks and corresponding to the neural network, determining an outermost merge layer included in each of the plurality of residual blocks, determining at least one fusion receiving layer from among a plurality of outermost merge layers of the plurality of residual blocks, determining a first fused layer group including a plurality of fused layers positioned in a previous path of the at least one fusion receiving layer, and generating a fused execution graph corresponding to a first single on-chip operation unit by performing the layer fusion on the plurality of fused layers.

According to an aspect of the present disclosure, a method of performing layer fusion on a plurality of layers included in a neural network for execution on hardware includes receiving an operation graph including a plurality of residual blocks and corresponding to the neural network, determining a plurality of fusion output candidate layers including an input layer of the operation graph, an outermost merge layer included in each of the plurality of residual blocks, a layer positioned between the input layer and an initial residual block, a layer positioned between two adjacent residual blocks, and a layer positioned between a final residual block and an output layer of the neural network, determining, as at least one fusion output layer, at least one fusion output candidate layer from among the plurality of fusion output candidate layers, determining at least one first fused layer group that includes the at least one fusion output layer and at least one layer positioned in a previous path of the at least one fusion output layer, and generating a fused execution graph corresponding to a first single on-chip operation unit by performing the layer fusion on layers included in the at least one first fused layer group.

According to an aspect of the present disclosure, an apparatus for performing layer fusion on a plurality of layers included in a neural network includes memory storing instructions, and one or more processors including processing circuitry. The instructions, when executed by the one or more processors individually or collectively, cause the apparatus to receive an operation graph corresponding to the neural network, detect, as a plurality of fusion receiving candidate layers, outermost merge layers included in each of a plurality of residual blocks included in the operation graph, detect a plurality of fusion output candidate layers positioned between two consecutive residual blocks of the plurality of residual blocks, obtain a cost for each of a plurality of layer fusion combinations corresponding to combinations of the plurality of fusion receiving candidate layers and the plurality of fusion output candidate layers, and generate a fused execution graph by performing layer fusion on the operation graph based on a layer fusion combination corresponding to a minimum cost from among the plurality of layer fusion combinations. A size of an output feature map of at least one fusion output candidate layer based on the layer fusion combination corresponding to the minimum cost is less than or equal to a bottom 25% from among sizes of output feature maps of the plurality of fusion output candidate layers.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram illustrating an electronic device, according to an embodiment;

FIG. 2 is a block diagram illustrating a neural network, according to an embodiment;

FIG. 3 is a block diagram illustrating a residual block and a split-merge block included in an operation graph corresponding to a neural network, according to an embodiment;

FIG. 4 is a block diagram illustrating an operation graph corresponding to a neural network, according to an embodiment;

FIGS. 5A and 5B are block diagrams illustrating candidate execution graphs corresponding to a neural network, according to an embodiment;

FIG. 6 is a block diagram illustrating an operation graph corresponding to a neural network, according to an embodiment;

FIGS. 7A and 7B are block diagrams illustrating candidate execution graphs corresponding to a neural network, according to an embodiment;

FIG. 8 is a flowchart illustrating a layer fusion method, according to an embodiment;

FIG. 9 is a block diagram illustrating a computing system, according to an embodiment; and

FIG. 10 is a block diagram illustrating a computing system, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the present disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

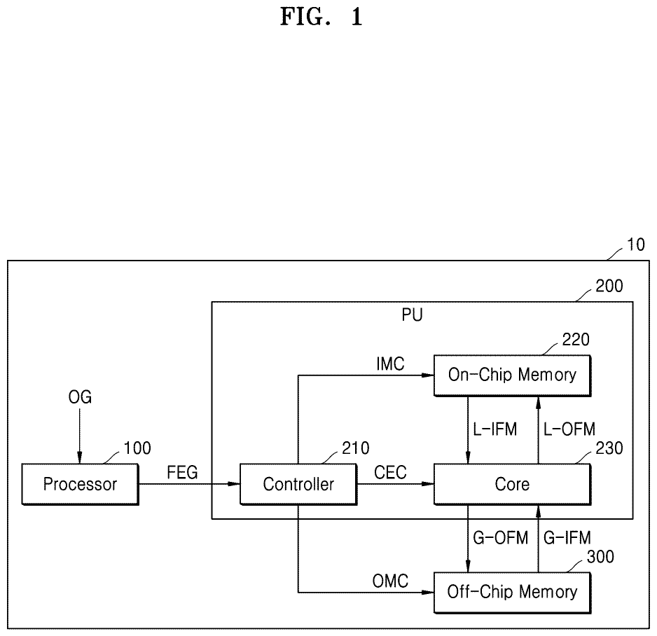

FIG. 1 is a block diagram illustrating an electronic device, according to an embodiment.

Referring to FIG. 1, an electronic device 10 may include a processor 100, a processing unit (PU) 200, and an off-chip memory 300. The electronic device 10 may refer to a certain hardware device for processing a neural network. For example, the electronic device 10 may be and/or may include an integrated circuit manufactured by a semiconductor process, and the processor 100, the processing unit 200, and the off-chip memory 300 may be included in a single integrated circuit. The electronic device 10 may provide useful functions by processing the neural network.

A neural network and/or an artificial neural network may include a statistical learning algorithm that may mimic biological neurons using machine learning. The neural network may refer to a model in which artificial neurons, networked by coupling of synapses, may provide a problem-solving capability by changing synaptic coupling strength through the machine learning. The neural network, as non-limiting examples, may include at least one of a convolutional neural network (CNN), a recurrent neural network (RNN), a perceptron, a feed forward (FF), a radial basis function (RBF) network, a deep feed forward (DFF), a long short-term memory (LSTM), a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a Kohonen network (KN), an attention network (AN), or the like.

Referring to FIG. 1, the processing unit 200, according to an embodiment, may include a controller 210, an on-chip memory 220, and a core 230. In an embodiment, the processing unit 200 may be and/or may include a dedicated hardware device designed to process the neural network, and may be referred to as a neural processing unit (NPU).

The on-chip memory 220 may store data that may be used for processing the neural network. In some embodiments, the on-chip memory 220 may be and/or may include volatile memory, such as, but not limited to, static random access memory (SRAM). However, the on-chip memory 220, according to embodiments of the present disclosure, is not limited thereto. For example, the on-chip memory 220 may be and/or may include non-volatile memory, such as, but not limited to, flash memory, resistive random access memory (RRAM), or the like. The on-chip memory 220, according to an embodiment, may be referred to as a scratchpad memory and may refer to a memory located inside the processing unit 200.

The off-chip memory 300 may store data that may be used for processing the neural network. In some embodiments, the off-chip memory 300 may be and/or may include volatile memory, such as, but not limited to, dynamic random access memory (DRAM). However, the off-chip memory 300, according to embodiments of the present disclosure, is not limited thereto. For example, the off-chip memory 300 may be and/or may include non-volatile memory such as, but not limited to, flash memory, RRAM, or the like. The off-chip memory 300, according to an embodiment, may refer to a memory located outside of the processing unit 200.

The processor 100, according to an embodiment, may perform layer fusion for the neural network. The processor 100 may perform the layer fusion for optimizing neural network processing. The layer fusion, according to an embodiment, may be performed by a compiler. For example, the compiler may be executed in the processor 100 configured to execute a series of instructions.

The layer fusion may refer to an optimization method of combining a plurality of layers constituting a neural network into one operation unit, which may be referred to as a single operation unit, potentially improving operation efficiency, and potentially minimizing the number of accesses to the off-chip memory 300, when compared to a related neural network.

As described above, the neural network processing may be performed in the processing unit 200. In a neural network processing operation, a feature map may be generated from each of a plurality of layers, and the generated feature map may be required for an operation in a next layer. Accordingly, the feature map may be stored in a memory and then loaded to the next layer. For example, a feature map may be stored in the on-chip memory 220 and/or the off-chip memory 300, and the feature map stored in the on-chip memory 220 and/or the off-chip memory 300 may be loaded from the on-chip memory 220 and/or the off-chip memory 300 to the core 230 for an operation.

The on-chip memory 220 may be located inside the processing unit 200 and may be disposed adjacent to the core 230. Accordingly, the core 230 may perform a fast access to the on-chip memory 220. Therefore, when storing the feature map in the on-chip memory 220 and loading the stored feature map, relatively less time and power may be required than when storing the feature map in the off-chip memory 300 and loading the stored feature map, when compared to related neural networks.

The off-chip memory 300 may use a separate data transfer interface, such as, but not limited to, direct memory access (DMA) or a bus, to transmit and/or receive data. Accordingly, accessing the off-chip memory 300 may require relatively more time and power than accessing the on-chip memory 220.

Therefore, with consideration for the accessibility of the core 230 to the on-chip memory 220 and the off-chip memory 300, performing of the layer fusion, in consideration of sizes of feature maps and/or preset orders of operation processing, may be necessary for efficient processing of the neural network. The processor 100, according to an embodiment, may perform the layer fusion, and by performing operations according to the layer fusion, the core 230 may maximize use of the on-chip memory 220 and/or may reduce access to the off-chip memory 300, thereby potentially reducing time and/or power consumed for the neural network processing, when compared to a related neural network.

When the compiler performs a full search for the entire neural network to perform the layer fusion, that is, when searching all points where the layer fusion may be possible, a very long compile time may be required. On the other hand, when the compiler searches only a portion of the neural network for fast compilation, the layer fusion performance may deteriorate, in comparison.

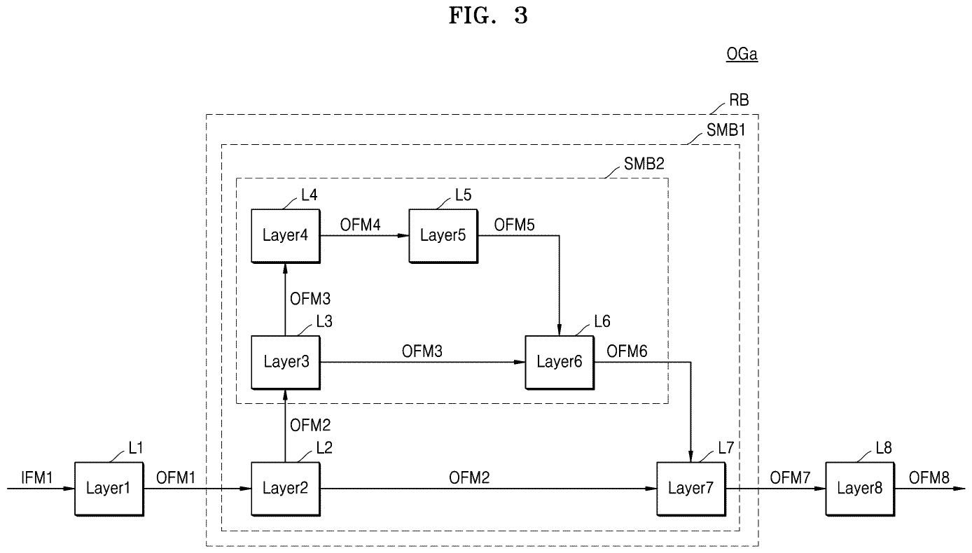

In an embodiment, the processor 100 may detect a plurality of residual blocks included in an operation graph OG corresponding to the entire neural network. The processor 100 may detect an outermost merge layer included in each of the plurality of residual blocks. As used herein, the outermost merge layer may be referred to as a fusion receiving candidate layer. The processor 100 may determine at least one of a plurality of fusion receiving candidate layers as a fusion receiving layer. However, embodiments of the present disclosure are not limited thereto. The processor 100, according to an embodiment, may not determine the fusion receiving layer among the plurality of fusion receiving candidate layers. For example, a plurality of layers included in each of a plurality of residual blocks included in the operation graph OG, according to an embodiment, may be included in a single fused layer group. The processor 100 may perform the layer fusion on the plurality of layers based on the fusion receiving layer to generate a fused layer group corresponding to a single on-chip operation unit as a single operation unit. The processor 100 may perform the layer fusion to generate a fused execution graph FEG including at least one fused layer group. The outermost merge layer, according to an embodiment, is further described with reference to FIG. 3.

As described above, the processor 100, according to an embodiment, may not detect all points at which layer fusion may be possible, but only on fusion receiving candidate layers (e.g., outermost merge layers). By performing the layer fusion based on the fusion receiving candidate layers, an efficient search for layer fusion combinations may be performed, when compared to related neural networks. The fusion receiving candidate layers and the fusion receiving layers, according to an embodiment, are further described with reference to FIG. 3 and the following figures.

As used herein, the fusion receiving layer may refer to a layer that receives an output of a fused layer group generated by performing the layer fusion on the plurality of layers. The processor 100, according to an embodiment, may perform the layer fusion on the plurality of layers located in an upstream path of the fusion receiving layer.

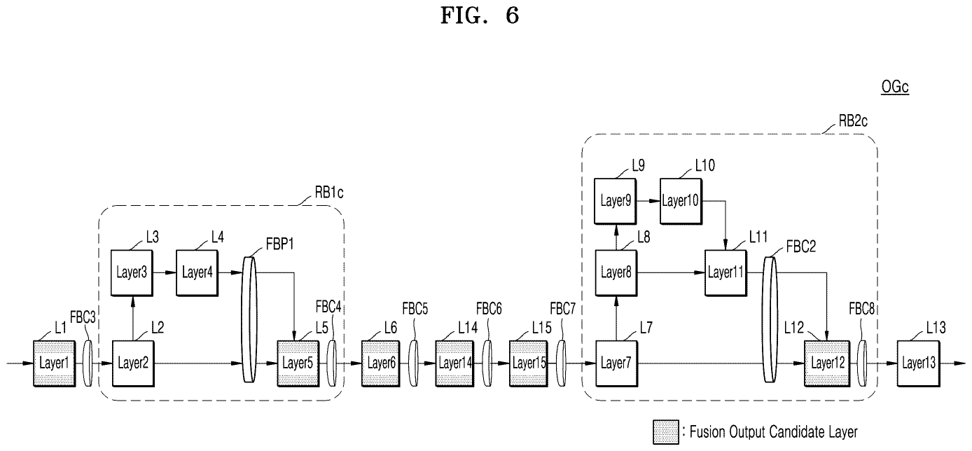

As used herein, layers in the operation graph OG may be referred to as fusion output candidate layers, including an input layer, an outermost merge layer, a layer positioned between an input layer and a residual block, a layer positioned between two adjacent residual blocks, and a layer positioned between a final residual block and an output layer. The processor 100, according to an embodiment, may determine at least one of a plurality of fusion output candidate layers as a fusion output layer. The processor 100 may perform the layer fusion on the plurality of layers into a single on-chip operation unit to generate the fused execution graph FEG. Fusion output candidate layers, according to an embodiment, are further described with reference to FIG. 6 and the following figures.

As used herein, the fusion output layer may refer to a layer located at the last end of a forward path including the plurality of layers included in the fused layer group. Outputs of the fusion output layer may be the outputs of the fused layer group.

Referring to FIG. 1, the processor 100 may receive the operation graph OG. As used herein, the operation graph OG may structurally represent relationships and/or flows among a plurality of layers included in the neural network. The processor 100, according to an embodiment, may perform layer fusion on the operation graph OG to generate the fused execution graph FEG.

The processing unit 200, according to an embodiment, may perform neural network operations based on the fused execution graph FEG. The controller 210 may interpret the fused execution graph FEG and generate a plurality of instructions for the neural network processing. The controller 210 may generate a core execution command CEC, an internal memory command IMC, and an off-chip memory command OMC. The core execution command CEC may include an order and/or type of operations through the layer fusion (e.g., a convolution operation, a rectified linear unit (ReLU) operation, an add operation, a pooling operation, or the like), an input feature map, a storage location of a weight, and a memory location for storing an output feature map. The core 230 may receive the core execution command CEC from the controller 210. The core 230 may load a weight and/or an input feature map that may be needed for an operation from the on-chip memory 220 or the off-chip memory 300 based on the core execution command CEC and may perform the operation according to the core execution command CEC in the preset order.

The on-chip memory 220 may output a local-input feature map L-IFM to the core 230 based on the internal memory command IMC. The on-chip memory 220 may store a local-output feature map L-OFM generated as a result of an operation in the core 230. The off-chip memory 300 may output a global-input feature map G-IFM to the core 230 based on the off-chip memory command OMC. The off-chip memory 300 may store a global-output feature map G-OFM generated as a result of an operation in the core 230. As described above, a time required for loading the local-input feature map L-IFM and storing the local-output feature map L-OFM may be less than a time required for loading the global-input feature map G-IFM and storing the global-output feature map G-OFM.

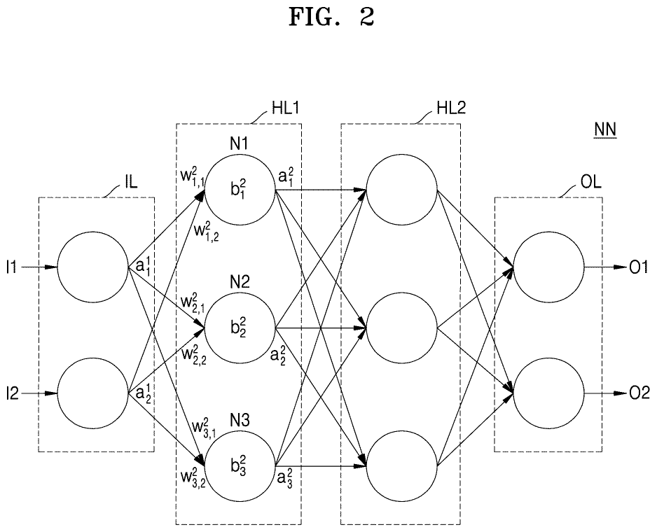

FIG. 2 is a block diagram illustrating a neural network, according to an embodiment.

A neural network NN of FIG. 2 is for aiding understanding of a neural network structure, according to an embodiment, and as such, embodiments of the present disclosure are not limited thereto.

Referring to FIG. 2, the neural network NN may have a structure including an input layer IL, hidden layers (e.g., a first hidden layer HL1 and a second hidden layer HL2), and an output layer OL. The neural network NN may perform an operation based on received input data (e.g., a first input data I1 and a second input data I2) and may generate output data (e.g., a first output data O1 and a second output O2) based on the operation result.

The neural network NN may be and/or may include a deep neural network (DNN) including two (2) or more hidden layers and/or n-layer neural networks. For example, the neural network NN may be and/or may include a DNN including the input layer IL, the first and second hidden layers HL1 and HL2, and the output layer OL. The plurality of hidden layers may be implemented with at least one of a convolutional layer, a fully-connected layer, a softmax layer, or the like. For example, the convolutional layer may include convolution, pooling, and/or activation function operations. Alternatively or additionally, a separate layer may be constituted for each of convolution, pooling, and/or activation function operations. However, as described above, the neural network, according to embodiments of the present disclosure, is not limited thereto.

Outputs of the plurality of layers IL, HL1, HL2, and OL may be referred to as feature maps. The plurality of layers IL, HL1, HL2, and OL may receive feature maps generated from a previous stage or layer as input feature maps, perform operations on the input feature maps, and generate output feature maps. The feature maps may refer to data in which various features of input data recognizable by the neural network NN are represented.

The neural network NN, when having the DNN structure, may include more layers capable of extracting valid information, and thus the neural network NN may process complex datasets. Although the neural network NN of FIG. 2 is illustrated as including four (4) layers (e.g., the plurality of layers IL, HL1, HL2, and OL), embodiments of the present disclosure are not limited thereto, and the neural network NN may include fewer (e.g., less than four (4)) or more (e.g. more than four (4)) layers. In addition, the neural network NN may include layers of various structures different from those illustrated in FIG. 2.

Each of the plurality of layers IL, HL1, HL2, and OL included in the neural network NN may include a plurality of artificial neurons (hereinafter referred to as neurons). Referring to FIG. 2, the input layer L1 may include two (2) neurons, and each of the first and second hidden layers HL1 and HL2 may include three (3) neurons. However, this is merely an example, and each of the layers included in the neural network NN may include various numbers of neurons.

Neurons included in each of the plurality of layers IL, HL1, HL2, and OL of the neural network NN may be connected to each other to exchange data. One neuron may receive data from other neurons to perform an operation and may output the result of the operation to still other neurons.

The input and output of each neuron (e.g., a first neuron N1, a second neuron N2, and a third neuron N3) may be referred to as an input activation and an output activation, respectively. That is, an activation may be an output of one neuron and at the same time a parameter corresponding to inputs of neurons included in a next layer. In this regard, each of the neurons may determine its output activation based on input activations

$$( e . g . , {a}_{1}^{1} , {a}_{2}^{1} , {a}_{1}^{2} , {a}_{2}^{2} , {a}_{3}^{2} , … )$$

received from neurons included in a previous layer, as well as weights

$$( e . g . , {w}_{1 , 1}^{2} , {w}_{1 , 2}^{2} , {w}_{2 , 1}^{2} , {w}_{2 , 2}^{2} , {w}_{3 , 1}^{2} , {w}_{3 , 2}^{2} , … )$$

and biases

$$( e . g . , {b}_{1}^{2} , {b}_{2}^{2} , {b}_{3}^{2} , … ) .$$

Weights and biases may be parameters, which may be referred to as weight parameters, that may be used to calculate output activations of each neuron, wherein the weights are values assigned to connections between neurons, and the biases represent weights associated with individual neurons.

Although the above description is based on the first to third neurons of the first hidden layer HL1, similar descriptions may also apply to the neurons of the input layer IL, the second hidden layer HL2, and the output layer OL.

FIG. 3 is a block diagram illustrating a residual block and a split-merge block included in an operation graph corresponding to a neural network, according to an embodiment.

Referring to FIG. 3, an operation graph OGa, according to an embodiment, may include a plurality of layers (e.g., a first layer L1, a second layer L2, a third layer L3, a fourth layer L4, a fifth layer L5, a sixth layer L6, a seventh layer L7, and an eighth layer L8). The operation graph OGa, according to an embodiment, may correspond to the neural network processed by the processing unit 200 of FIG. 1. The structures and roles of the plurality of layers L1 to L8 included in the operation graph OGa may be similar in many respects to the plurality of layers L1 to L4 of FIG. 2, and may include additional features not mentioned above. Consequently, repeated descriptions of the plurality of layers L1 to L8 described above with reference to FIG. 2 may be omitted for the sake of brevity.

As used herein, the first layer of the operation graph OGa may be referred to as the input layer, and the final layer may be referred to as the final layer. That is, a layer receiving an input of the operation graph OGa may be referred to as an input layer, and a layer generating an output may be referred to as an output layer. For example, in the operation graph OGa of FIG. 3, the first layer L1 may be referred to as an input layer, and the eighth layer L8 may be referred to as an output layer. In addition, although a layer of a graph may refer to a functional unit of an operation, the disclosure applicable to the layer of the graph may also be applied to nodes of the graph, which may refer to units representing operations and/or data of the graph.

Referring to FIG. 3, the first layer L1 may receive a first input feature map IFM1, may perform an operation on the first input feature map IFM1, and may generate a first output feature map OFM1. The first output feature map OFM1 may be an input feature map of the next layer, that is, the second layer L2. The second layer L2 may receive the first output feature map OFM1 as an input feature map, may perform an operation on the first output feature map OFM1, and may generate a second output feature map OFM2. The third layer L3 may receive the second output feature map OFM2 as an input feature map, may perform an operation on the second output feature map OFM2, and may generate a third output feature map OFM3. The fourth layer L4 may receive the third output feature map OFM3 as an input feature map, may perform an operation on the third output feature map OFM3, and may generate a fourth output feature map OFM4. The fifth layer L5 may receive the fourth output feature map OFM4 as an input feature map, may perform an operation on the fourth output feature map OFM4, and may generate a fifth output feature map OFM5. The sixth layer L6 may receive the third output feature map OFM3 and the fifth output feature map OFM5 as input feature maps, may perform an operation on the third and fifth output feature maps OFM3 and OFM5, and may generate a sixth output feature map OFM6. The seventh layer L7 may receive the second output feature map OFM2 and the sixth output feature map OFM6 as input feature maps, may perform an operation on the second and sixth output feature maps OFM2 and OFM6, and may generate a seventh output feature map OFM7. The eighth layer L8 may receive the seventh output feature map OFM7 as an input feature map, may perform an operation on the seventh output feature map OFM7, and may generate an eighth output feature map OFM8.

Referring to FIG. 3, the operation graph OGa may include a residual block RB. The residual block RB may include the second to seventh layers L2 to L7. The residual block RB, according to an embodiment, may include a skip-connection described below, which may be a structure that may be used to improve learning stability and/or performance in a neural network.

Referring to FIG. 3, the residual block RB may include a first split-merge block SMB1. A split-merge block, according to an embodiment, may include a split layer and a merge layer. As used herein, a split layer may refer to a layer in which branches may be generated in an operation graph (e.g., the second layer L2 and the third layer L3 of FIG. 3), and a merge layer may refer to a layer in which branches may be merged in the operation graph (e.g., the sixth layer L6 and the seventh layer L7 of FIG. 3). The split-merge block may include a skip-connection structure including a split layer, a merge layer, and at least one layer positioned between the split layer and the merge layer. For example, the first split-merge block SMB1 may include the second layer L2 corresponding to the split layer, the seventh layer L7 corresponding to the merge layer, and the third to sixth layers L3 to L6 formed between the second layer L2 and the seventh layer L7. Similarly, a second split-merge block SMB2 may include the third layer L3 corresponding to the split layer, the sixth layer L6 corresponding to the merge layer, and the plurality of layers L4 and L5 formed between the third layer L3 and the sixth layer L6. As used herein, the split layers and the merge layers may be referred to as a split-merge pair.

Referring to FIG. 3, because the second split-merge block SMB2 may be configured of a plurality of layers L3 to L6 formed between the split layer (e.g., L2) and the merge layer (e.g., L7) of the first split-merge block SMB1, it may be understood that the second split-merge block SMB2 is included in the first split-merge block SMB1.

An outermost merge layer, according to an embodiment, may refer to a merge layer included in one split-merge block. For example, referring to FIG. 3, the operation graph OGa may include the two merge layers L6 and L7. However, the sixth layer L6 is included in both the first split-merge block SMB1 and the second split-merge block SMB2. Accordingly, the sixth layer L6 may be the merge layer but may not be an outermost merge layer. In contrast, the seventh layer L7 may be included only in one split-merge block (e.g., SMB1), and thus may be referred to as the outermost merge layer, according to an embodiment.

Although the operation graph OGa illustrated in FIG. 3 may include one residual block RB, embodiments of the present disclosure are not limited thereto. An operation graph, according to an embodiment, may include a plurality of residual blocks. Furthermore, a residual block included in the operation graph, according to an embodiment, may include one (1) split-merge block or three (3) or more split-merge blocks.

A processor, according to an embodiment, may receive an operation graph corresponding to a neural network and including a plurality of residual blocks, and may detect the residual blocks included in the operation graph. The processor may determine the outermost merge layer included in the residual block as a fusion receiving candidate layer. The processor, according to an embodiment, may perform the layer fusion based on the fusion receiving candidate layer. A layer fusion method, according to an embodiment, may detect a plurality of residual blocks included in an operation graph and may perform the layer fusion, and thus power and time consumed for cost calculation according to detection frequency and results may be reduced, when compared to related neural networks. Furthermore, because layer fusion may be performed on an entire range of the operation graph, rather than a portion thereof, the neural network processing performance may be improved according to the layer fusion result, when compared to related neural networks.

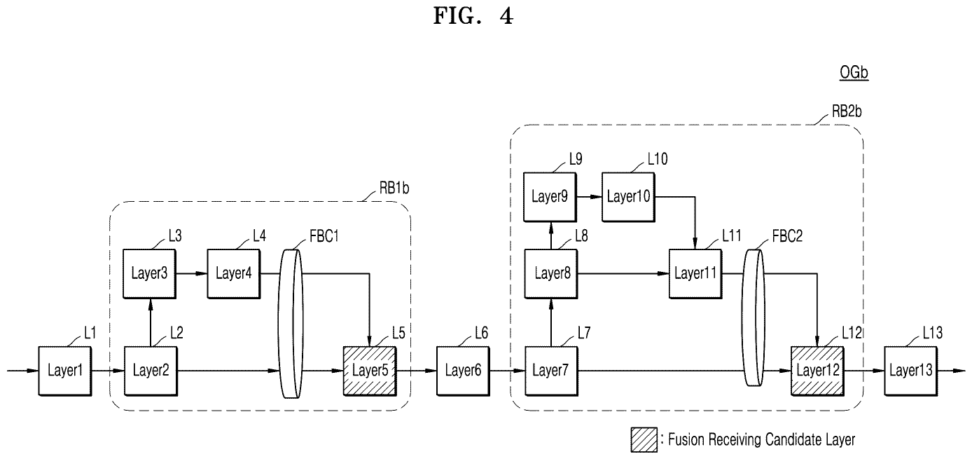

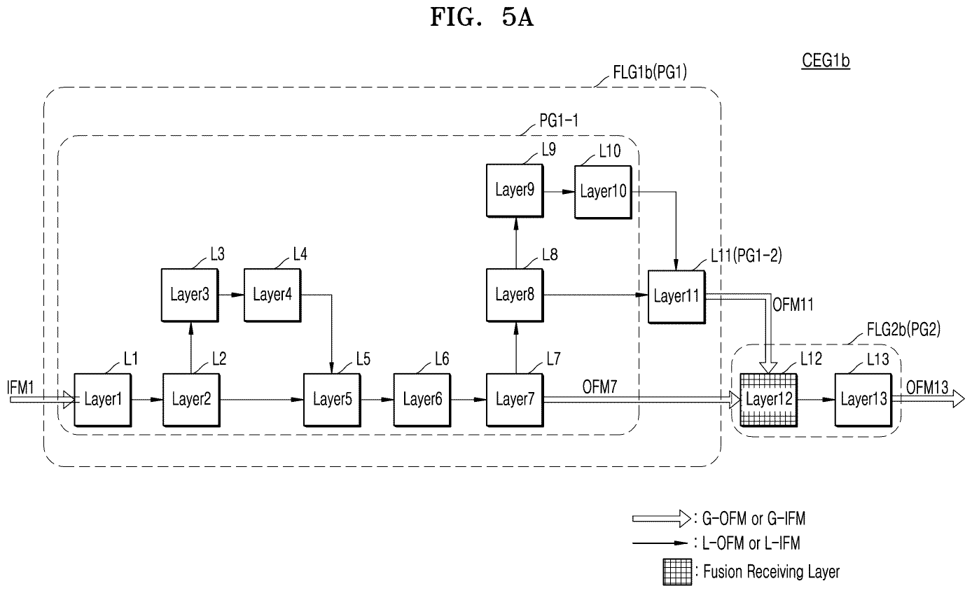

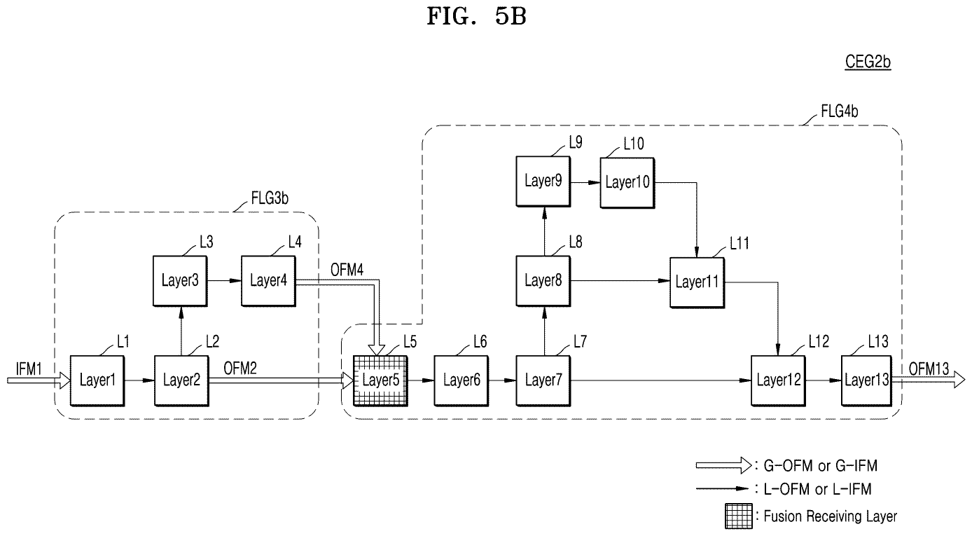

FIG. 4 is a block diagram illustrating an operation graph corresponding to a neural network, according to an embodiment.

Referring to FIG. 4, an operation graph OGb may include a plurality of layers (e.g., a first layer L1, a second layer L2, a third layer L3, a fourth layer L4, a fifth layer L5, a sixth layer L6, a seventh layer L7, an eighth layer L8, a ninth layer L9, a tenth layer L10, an eleventh layer L11, a twelfth layer L12, and a thirteenth layer L13). The operation graph OGb may include a first residual block RB1b including the second to fifth layers L2 to L5, and a second residual block RB2b including the seventh to twelfth layers L7 to L12. The residual blocks, split-merge blocks, split layers, and merge layers of FIG. 4 may include and/or may be similar in many respects to those described with reference to FIG. 3, and may include additional features not mentioned above. Consequently, repeated descriptions of the residual blocks, split-merge blocks, split layers, and merge layers described above with reference to FIG. 3 may be omitted for the sake of brevity.

The processor, according to an embodiment, may detect outermost merge layers of each of the plurality of residual blocks included in the operation graph OGb. As described above, the outermost merge layer may refer to the merge layer included in the residual block that is not included in any other split-merge block. For example, referring to FIG. 4, the merge layer included in the first residual block RB1b may be the fifth layer L5 which is included in one split-merge block, and thus the fifth layer L5 may correspond to the outermost merge layer. Continuing with reference to FIG. 4, the merge layers included in the second residual block RB2b may be the eleventh layer L11 and the twelfth layer L12, and the twelfth layer L12 may be included in one split-merge block, and thus the twelfth layer L12 may correspond to the outermost merge layer. In contrast, the split-merge block having the eleventh layer L11 as a merge layer may be included in the split-merge block having the seventh layer L7 as a split layer and the twelfth layer L12 as a merge layer. Therefore, the eleventh layer L11 may correspond to the merge layer, but because the eleventh layer L11 may be included in two (2) split-merge blocks, the eleventh layer L11 may not be the outermost merge layer.

The outermost merge layer, according to an embodiment, may be referred to as a fusion receiving candidate layer. A processor, according to an embodiment, may determine at least one of the fusion receiving candidate layers as a fusion receiving layer. However, as described above, the processor, according to an embodiment, may not determine the fusion receiving layer from among the plurality of fusion receiving candidate layers. The processor, according to an embodiment, may perform layer fusion on a plurality of layers located in a previous path of the determined fusion receiving layer.

As used herein, a region between the fusion receiving candidate layer and a plurality of previous layers adjacent to the fusion receiving layer may be referred to as a fusion boundary candidate. Referring to FIG. 4, a region between the fusion receiving candidate layer (e.g., the outermost merge layer), which may be the fifth layer L5 and a plurality of previous layers (e.g., L2 and L4) adjacent to the fifth layer L5, may be referred to as a first fusion boundary candidate FBC1. Similarly, a region between the fusion receiving candidate layer, which may be the twelfth layer L12 and a plurality of previous layers (e.g., L7 and L11) adjacent to the twelfth layer L12, may be referred to as a second fusion boundary candidate FBC2.

The processor, according to an embodiment, may determine whether to perform the layer fusion based on the fusion boundary candidates. For example, referring to FIG. 4, the processor may determine whether to perform the layer fusion with the first fusion boundary candidate FBC1 as a boundary (see FIG. 5B below), with the second fusion boundary candidate FBC2 as a boundary (see FIG. 5A below), or with both the first fusion boundary candidate FBC1 and the second fusion boundary candidate FBC2 as boundaries. Because the fusion boundary candidate may be determined based on the fusion receiving candidate layer, the processor's operation related to the fusion boundary candidate may result in the same outcome as detecting a plurality of fusion receiving candidate layers and determining the fusion receiving layer from among the plurality of fusion receiving candidate layers.

That is, the processor, according to an embodiment, may perform the layer fusion according to one of the layer fusion combinations based on the fusion receiving candidate layers. For example, referring to FIG. 4, a plurality of layer fusion combinations may include four (4) combinations. In particular, the combinations may include a first combination in which the fifth layer L5 is determined as a fusion receiving layer, a second combination in which the twelfth layer L12 is determined as a fusion receiving layer, a third combination in which both the fifth layer L5 and the twelfth layer L12 are determined as fusion receiving layers, and a fourth combination in which neither the fifth layer L5 nor the twelfth layer L12 is determined as a fusion receiving layer.

FIGS. 5A and 5B are block diagrams illustrating candidate execution graphs corresponding to a neural network, according to an embodiment.

Candidate execution graphs CEG1b and CEG2b shown in FIGS. 5A and 5B respectively illustrate some of the layer fusion combinations for the operation graph OGb shown in FIG. 4. Consequently, FIGS. 5A and 5B are described with reference to FIG. 4, and repeated descriptions already provided with reference to FIG. 4 may be omitted for the sake of brevity.

Referring to FIGS. 4 and 5A, the processor may determine the outermost merge layers, which are the fifth layer L5 and the twelfth layer L12, as fusion receiving candidate layers. That is, the processor may detect the fusion receiving candidate layers included in each of the plurality of residual blocks. Referring to FIG. 5A, the processor may determine the twelfth layer L12 among the two fusion receiving candidate layers L5 and L12 as a fusion receiving layer. When the twelfth layer L12 is determined as a fusion receiving layer, the layer fusion may be performed based on a region between the twelfth layer L12 and a plurality of previous layers adjacent to the twelfth layer L12 (e.g., the seventh layer L7 and the eleventh layer L11). The processor, according to an embodiment, may perform the layer fusion on the plurality of layers L1 to L11 located in a previous path of the layer L12 determined as a fusion receiving layer. The twelfth layer L12 determined as a fusion receiving layer may receive seventh and eleventh outputs OFM7 and OFM11 of a first fused layer group FLG1b including the plurality of layers L1 to L11.

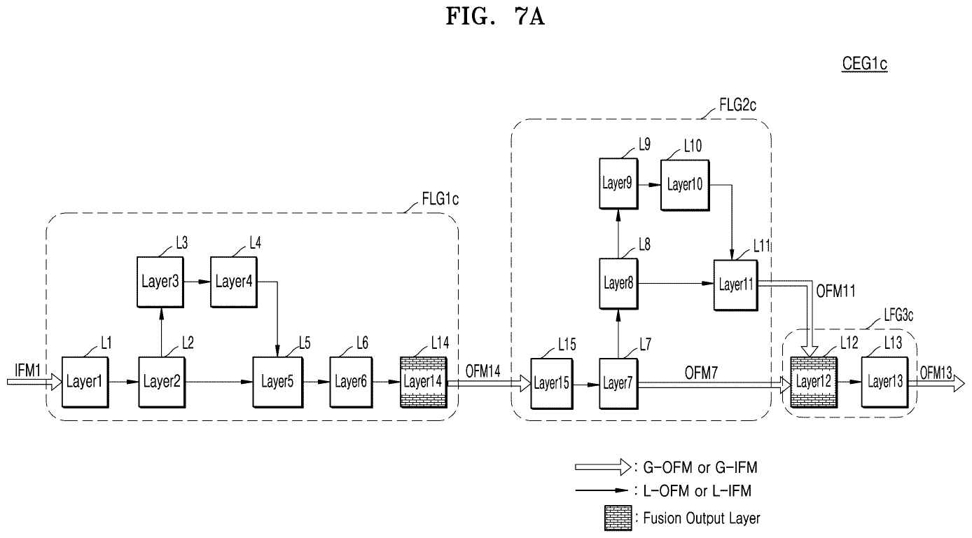

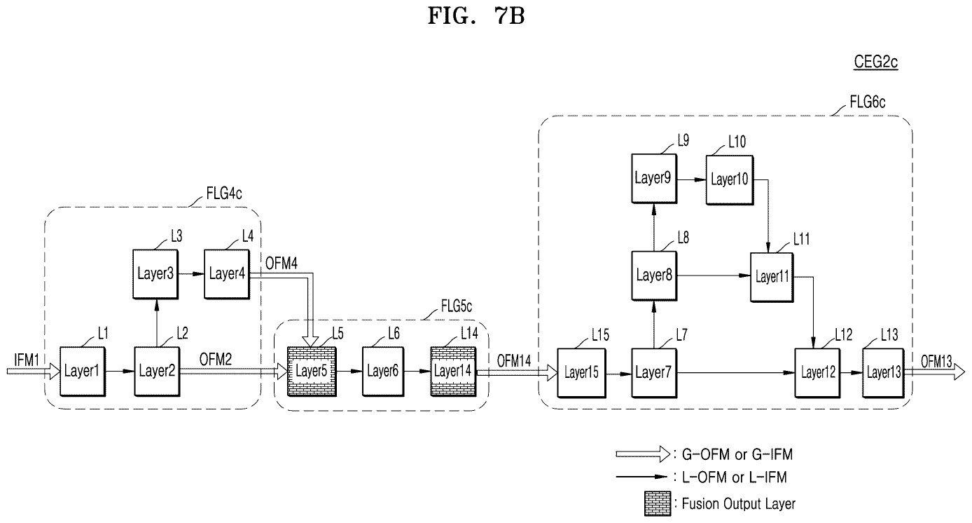

The thirteenth layer L13 in FIG. 5A may be a fusion output candidate layer as described below with reference to FIGS. 6, 7A, and 7B. As described below, whether to perform the layer fusion between the twelfth layer L12 and the thirteenth layer L13 may be determined based on the size of the output feature map of the thirteenth layer L13. For convenience of explanation, in FIG. 5A, it may be assumed that the size of the output feature map of the thirteenth layer L13 satisfies the conditions described below, and layer fusion is performed between the twelfth layer L12 and the thirteenth layer L13. As a result, the candidate execution graph CEG1b may include the first fused layer group FLG1b including the first to eleventh layers L1 to L11 and a second fused layer group FLG2b including the twelfth layer L12 and the thirteenth layer L13. However, the layer fusion method, according to embodiments of the present disclosure, is not limited thereto. For example, within the first fused layer group FLG1b shown in FIG. 5A, the layer fusion based on the fusion receiving layer and/or the fusion output layer may further be performed. For instance, among the plurality of layers L1 to L11 included in the first fused layer group FLG1b, the fifth layer L5 and the eleventh layer L11 may be the fusion receiving candidate layers, and the sixth layer L6 may be a fusion output candidate layer as described below. On this basis, the layer fusion may be performed on the plurality of layers L1 to L11 included in the first fused layer group FLG1b, and whether to perform the layer fusion may be determined through a cost comparison described below.

Referring to FIGS. 4 and 5B, the processor may determine the fifth layer L5 and the twelfth layer L12 corresponding to the outermost merge layers as fusion receiving candidate layers. That is, the outermost merge layer may be referred to as a fusion receiving candidate layer. Referring to FIG. 5B, the processor may determine the fifth layer L5, among the two fusion receiving candidate layers L5 and L12, as a fusion receiving layer. When the fifth layer L5 is determined as a fusion receiving layer, a boundary for the layer fusion may be positioned between the fifth layer L5 and a plurality of previous adjacent layers (e.g., the second layer L2 and the fourth layer L4) adjacent to the fifth layer L5. The processor may perform the layer fusion on the plurality of layers L1 to L4 located in a previous path of the fusion receiving layer L5. The processor may not determine the twelfth layer L12, which is the fusion receiving candidate layer, as a fusion receiving layer. The processor may perform the layer fusion for the fusion receiving layer L5 and for the plurality of layers L6 to L13 located in a subsequent path of the fusion receiving layer L5. As a result, the candidate execution graph CEG2b may include a third fused layer group FLG3b including the first layer to fourth layers L1 to L4 and a fourth fused layer group FLG4b including the fifth layer L5 to thirteenth layer L13. However, the layer fusion scheme, according to embodiments of the present disclosure, is not limited thereto. For example, within the third fused layer group FLG3b and the fourth fused layer group FLG4b shown in FIG. 5B, layer fusion based on the fusion output layer described below may further be performed.

A processor, according to an embodiment, may determine, as a fused execution graph, one candidate execution graph among a plurality of candidate execution graphs according to the layer fusion combinations based on the plurality of fusion receiving candidate layers.

For example, the processor may determine, between the candidate execution graph CEG1b of FIG. 5A and the candidate execution graph CEG2b of FIG. 5B, CEG1b as a fused execution graph. Accordingly, the processor may perform layer fusion on the operation graph (OGb of FIG. 4) to thereby generate a fused execution graph identical to the candidate execution graph CEG1b.

The processor, according to an embodiment, may calculate a cost for each of the plurality of candidate execution graphs and may determine a minimum cost among the plurality of costs. The cost may indicate and/or correspond to a time consumed for neural network processing according to a corresponding candidate execution graph. For example, the cost may correspond to a time from when an input feature map is loaded to an input layer to when an output feature map output from an output layer is stored in a memory (e.g., the off-chip memory 300). However, embodiments of the present disclosure are not limited thereto, and the cost, according to an embodiment, may further include a time consumed for loading weights for neural network operations.

According to an embodiment, the processor may, according to the layer fusion combination corresponding to a candidate execution graph having a minimum cost, determine, among the plurality of fusion receiving candidate layers, a fusion receiving layer. Accordingly, the processor may perform the layer fusion on an operation graph to generate a fused execution graph. For example, for the same operation graph OGb, among a cost of the candidate execution graph CEG1b of FIG. 5A and a cost of the candidate execution graph CEG2b of FIG. 5B, the cost of the candidate execution graph CEG1b may be smaller. Therefore, the processor may determine, as a fusion receiving layer, a fusion receiving candidate layer (e.g., the twelfth layer L12) according to the layer fusion combination corresponding to the candidate execution graph CEG1b.

For convenience of explanation, the foregoing description referred to a case where the number of fusion receiving layers determined with reference to FIGS. 5A and 5B is one (1). However, embodiments of the present disclosure are not limited thereto. The number of fusion receiving layers, according to an embodiment, may be a positive integer greater than zero (0). As described above, the number and/or position of the fusion receiving layer, according to an embodiment, may be determined based on a minimum cost among respective costs of the plurality of candidate execution graphs.

For example, a cost of a candidate execution graph in which the two fusion receiving candidate layers, namely, the fifth layer L5 and the twelfth layer L12 of the operation graph OGb of FIG. 4, are determined as fusion receiving layers may be less than the cost of the candidate execution graph CEG1b of FIG. 5A and the cost of the candidate execution graph CEG2b of FIG. 5B. In such a case, contrary to the foregoing description with reference to FIGS. 5A and 5B, a layer fusion group may be determined for a plurality of layers positioned in the previous path of each of the fifth layer L5 and the twelfth layer L12. That is, the processor may perform the layer fusion on the operation graph OGb of FIG. 4 to thereby generate a fused execution graph including three fused layer groups. Referring to the above example and FIG. 4, each of the three (3) fused layer groups may include the first layer to the fourth layer L1 to L4, the fifth layer to the eleventh layer L5 to L11, and the twelfth layer to the thirteenth layer L12 to L13.

The processor, according to an embodiment, may calculate costs of respective candidate execution graphs by a dynamic programming scheme. The dynamic programming scheme may be understood as a scheme of solving an entire problem by dividing the entire problem into subproblems. That is, the processor, according to an embodiment, may, based on the above fusion receiving layer and the fusion output layer described below, partition the operation graph into a plurality of partial graphs.

For example, referring to FIGS. 4 and 5A, as the twelfth layer L12 is determined as a fusion receiving layer, the operation graph OGb of FIG. 4 may be layer-fused into the first fused layer group FLG1b and the second fused layer group FLG2b, as shown in FIG. 5A. For convenience of description, the first fused layer group FLG1b and the second fused layer group FLG2b may be referred to as a first partial graph PG1 and a second partial graph PG2, respectively. The cost of the candidate execution graph CEG1B of FIG. 5A may be determined based on costs of the first partial graph PG1 and the second partial graph PG2. The costs of the partial graphs may be determined based on the fusion receiving candidate layers and the fusion output candidate layers, according to an embodiment. For example, the cost of the first partial graph PG1 may be a cost according to the plurality of layer fusion combinations based on the fusion receiving candidate layer and the fusion output candidate layer, according to an embodiment. However, in the example with reference to FIG. 5A, only the fusion receiving candidate layer may be considered for convenience of description. The first partial graph PG1 may include two residual blocks and may include two outermost merge layers contained in the two residual blocks. Although the eleventh layer L11 is not the outermost merge layer in the operation graph OGb of FIG. 4, from the viewpoint of first partial graph PG1, the eleventh layer L11 may be the outermost merge layer because of being included in one split-merge block. Therefore, because the two fusion receiving candidate layers are included in the first partial graph PG1, the number of layer fusion combinations for the first partial graph PG1 may be four (4). The processor may calculate four (4) costs for the four (4) layer fusion combinations for the first partial graph PG1. The four (4) costs may undergo memoization.

Among the four (4) layer fusion combinations for the first partial graph PG1 in the above example, some may include a fusion receiving candidate layer. For example, in a layer fusion combination in which the eleventh layer L11 included in the first partial graph PG1 is the fusion receiving layer, the first partial graph PG1 may include a 1st-1 partial graph PG1-1 including the first to tenth layers L1 to L10 and a 1st-2 partial graph PG1-2 including the eleventh layer L11. Because the 1st-1 partial graph PG1-1 includes the fifth layer L5 as a fusion receiving candidate layer, the number of layer fusion combinations for the 1st-1 partial graph PG1-1 is two (2). A cost of the layer fusion combinations for the 1st-1 partial graph PG1-1 may be memoized. Thus, considering only the fusion receiving candidate layers according an embodiment, the cost for the first partial graph PG1 may be the smallest of all six (6) costs. Similarly, the cost for the second partial graph PG2 may be calculated, and based thereon, a cost of a first candidate execution graph CEGb1 may be determined. As described above, the processor, according to the present disclosure, may calculate a cost for each of a plurality of candidate execution graphs and may determine a minimum cost (e.g., the smallest) from among the costs of each of the plurality of candidate execution graphs. The processor may determine, as a fused execution graph, a candidate execution graph corresponding to the minimum cost, and may perform the layer fusion on an operation graph to generate the fused execution graph.

The cost calculation process, according to an embodiment, as described above, may consider only the fusion receiving candidate layer. Therefore, when a fusion output candidate layer described below is also considered, the number of costs to be calculated and/or compared may increase. However, complexity of cost calculation for the layer fusion combinations through the dynamic programming scheme may be lower than complexity of cost calculation for all layer fusion combinations for all fusion candidate layers, when compared to a related neural network.

For example, when calculating a cost of a first partial graph GP1 by considering together the above-described fusion receiving candidate layer and a fusion output candidate layer described below, the complexity of the cost calculation may be proportional to n². Here, n is the sum of the number of fusion receiving candidate layers and the number of fusion output candidate layers included in a graph, according to an embodiment. In contrast, the complexity of cost calculation for all layer fusion combinations for all fusion candidate layers may be proportional to 2ⁿ.

As described above, a cost for a candidate execution graph may be determined as a sum of costs for a plurality of partial graphs included in a candidate execution graph. For example, when the candidate execution graph includes a first partial graph and a second partial graph, the processor may perform a memoization of first costs of a plurality of layer fusion combinations for the first partial graph. In addition, the processor may perform a memoization of a second cost of a layer fusion combination for the second partial graph.

A fused layer group, according to an embodiment, may include a plurality of layers fused through the layer fusion. The fused layer group may be executed by the core 230 of FIG. 1 as a single on-chip operation unit. Inputs and outputs of the fused layer group may correspond to the global-input feature map G-IFM and the global-output feature map G-OFM. Feature maps between the plurality of layers included in the fused layer group may correspond to the local-input feature map L-IFM or the local-output feature map L-OFM. Referring to the foregoing, by minimizing access to the off-chip memory through the layer fusion, according to an embodiment, the processing unit 200 of FIG. 1 may efficiently perform the neural network processing, when compared to a related neural network.

As described above, the processor, according to an embodiment, may perform the layer fusion on the plurality of layers (e.g., the first layer L1 to the eleventh layer L11) located in the previous path of the fusion receiving layer (e.g., the twelfth layer L12 of FIG. 5A). Accordingly, the outermost merge layer (e.g., the twelfth layer L12) and the split layer (e.g., the seventh layer L7) forming the split-merge pair may be included in different fused layer groups. When the plurality of layers included in the split-merge block are layer-fused into two (2) fused layer groups, in a case where the fusion receiving layer (e.g., a merge layer) and the split layer forming the split-merge pair are included in the same fused layer group as the fusion receiving layer, a cycle dependency may occur. When the cycle dependency occurs, an operation order may be determined, and scheduling by the compiler and an operation in the core may fall into a deadlock. Therefore, when the plurality of layers included in the split-merge block, according to an embodiment, are included in different fused layer groups, the outermost merge layer and the split layer forming the split-merge pair may not be included in the same fused layer group.

FIG. 6 is a block diagram illustrating an operation graph corresponding to a neural network, according to an embodiment.

Referring to FIG. 6, an operation graph OGc may include first to fifteenth layers L1 to L15. The operation graph OGc including first and second residual blocks RB1c and RB2c of FIG. 6 may differ from the operation graph OGb of FIG. 4 in that fourteenth and fifteenth layers L14 and L15 may be included between the sixth layer L6 and the seventh layer L7. Consequently, repeated descriptions of the operation graph OGc described above with reference to FIG. 4 may be omitted for the sake of brevity.

The processor, according to an embodiment, may refer to an input layer, an outermost merge layer, a layer positioned between the input layer and a first residual block, a layer positioned between two adjacent residual blocks, and a layer positioned between a final residual block and an output layer as a fusion output candidate layer. The processor, according to an embodiment, may determine at least one of the plurality of fusion output candidate layers as a fusion output layer.

Referring to FIG. 6, the operation graph OGc may include six (6) fusion output candidate layers (e.g., the first layer L1, the fifth layer L5, the sixth layer L6, the twelfth layer L12, the fourteenth layer L14, and the fifteenth layer L15) as described above.

The processor, according to an embodiment, may determine at least one among a plurality of fusion receiving candidate layers and a plurality of fusion output candidate layers included in the operation graph as a fusion receiving layer or the fusion output layer.

As described above, the processor may perform the layer fusion on layers located in the previous path of the fusion receiving layer. In addition, the processor may determine costs for layer fusion combinations according to the dynamic programming scheme, and may determine a fusion receiving layer corresponding to a layer fusion combination with a minimum cost.

The processor, according to an embodiment, may determine at least one fusion output layer based on a size of an output feature map of each of the plurality of fusion output candidate layers. A ratio of the number of at least one of the fusion output layers to the total number of candidate layers (e.g., the sum of the numbers of fusion receiving candidate layers and fusion output candidate layers), according to an embodiment, may be less than or equal to a preset threshold ratio. For example, referring to FIG. 6, a preset threshold ratio may be 25%, and since the number of fusion output candidate layers (e.g., the first layer L1, the fifth layer L5, the sixth layer L6, the twelfth layer L12, the fourteenth layer L14, and the fifteenth layer L15) is six (6), considering the threshold ratio (e.g., 25%), the number of layers determined as fusion output layers may be one (1). The processor, according to an embodiment, may select fusion output layers in the order of smaller sizes of output feature maps within a range according to the threshold ratio. For example, when a size of an output feature map of the fourteenth layer L14 is the smallest among the plurality of fusion output candidate layers (e.g., the first layer L1, the fifth layer L5, the sixth layer L6, the twelfth layer L12, the fourteenth layer L14, and the fifteenth layer L15), the processor may determine the fourteenth layer L14 as a fusion output layer.

A size of an output feature map of at least one fusion output layer, according to an embodiment, may be less than or equal to a preset threshold. For example, the threshold may be an average value or a median value of sizes of output feature maps of a plurality of layers included in the neural network, but the threshold, according to embodiments of the present disclosure, is not limited thereto. For example, an average value and/or a median value of output feature map sizes of the plurality of fusion output candidate layers (e.g., the first layer L1, the fifth layer L5, the sixth layer L6, the twelfth layer L12, the fourteenth layer L14, and the fifteenth layer L15), or of the plurality of layers L1 to L13 included in the operation graph OGc, may be greater than an output feature map size of the fourteenth layer L14. In this case, the processor may determine the fourteenth layer L14 as a fusion output layer.

FIGS. 7A and 7B are block diagrams illustrating candidate execution graphs corresponding to a neural network, according to an embodiment.

FIGS. 7A and 7B are block diagrams of some of a plurality of layer fusion combinations possible in the operation graph OGc of FIG. 6. FIG. 7A illustrates a case where the twelfth layer L12 is determined as a fusion receiving layer as described above with reference to FIG. 5A. Similarly, FIG. 7B illustrates a case where layer L5 is determined as a fusion receiving layer as described above with reference to FIG. 5B. Therefore, repeated descriptions may be omitted for the sake of brevity.

Candidate execution graphs CEG1c and CEG2c illustrated in FIGS. 7A and 7B illustrate a case where both the fusion receiving candidate layers and the fusion output candidate layers described above are considered. However, embodiments of the present disclosure are not limited thereto, and as described above, the layer fusion may be performed based only on the fusion receiving candidate layers. Alternatively or additionally, the layer fusion may be performed based only on the fusion output candidate layers. Alternatively or additionally, as shown in FIGS. 7A and 7B, the layer fusion may be performed based on both the fusion receiving candidate layers and the fusion output candidate layers. In each case, a fused execution graph may be generated based on the minimum cost as described above.

FIG. 7A illustrates a case where, among fusion output candidate layers (e.g., the first layer L1, the fifth layer L5, the sixth layer L6, the twelfth layer L12, the fourteenth layer L14, and the fifteenth layer L15), described above with reference to FIG. 6, the fourteenth layer L14 is determined as a fusion output layer and, among fusion receiving candidate layers L5 and L12, the twelfth layer L12 is determined as a fusion receiving layer.

As described above, when the fusion receiving layer is determined, the plurality of layers located in the previous path of the fusion receiving layer may be layer-fused. Accordingly, the fusion receiving layer may receive the output of the fused layer group. As described above, the fusion output layer is determined based on the size of an output feature map, and layer fusion may be performed on the fusion output layer and at least one layer located in a previous path of the fusion output layer based on the fusion output layer. For example, referring to FIG. 7A, the output feature map size of the fourteenth layer L14 may be the smallest among the output feature maps of the fusion output candidate layers (e.g., the first layer L1, the fifth layer L5, the sixth layer L6, the twelfth layer L12, the fourteenth layer L14, and the fifteenth layer L15), and when the output feature map size is relatively small, for efficient neural network processing, layer fusion may be performed on the fourteenth layer L14 and at least one layer (e.g., L1 to L6) in a previous path of the fourteenth layer L14 such that the output feature map of the fourteenth layer L14, which is relatively small, is stored in the off-chip memory 300 of FIG. 1 having poor accessibility, and larger output feature maps of the remaining layers are stored in the on-chip memory 220 of FIG. 1 having good accessibility. By storing relatively small output feature maps in the off-chip memory 300, the neural network may be processed efficiently, when compared to a related neural network. The processor, according to an embodiment, may store each output feature map of the plurality of layers included in the fused layer group in the on-chip memory 220 and may load each stored feature map from the off-chip memory 300. In this case, the processor may perform tiling on relatively large output feature maps. As used herein, tiling may refer to dividing a large feature map into a small fixed size and performing an operation on each divided unit. The tiling may be performed by the processor.

Thus, the candidate execution graph CEG1c may include a first fused layer group FLG1c including the first layer to the sixth layer L1 to L6 and the fourteenth layer L14, a second fused layer group FLG2c including the seventh layer to the eleventh layer L7 to L11 and the fifteenth layer L15, and a third fused layer group FLG3c including the twelfth layer L12 and the thirteenth layer L13.

The candidate execution graph CEG2c illustrated in FIG. 7B may be readily understood from the foregoing description. FIG. 7B illustrates a case where, among the fusion output candidate layers (e.g., the first layer L1, the fifth layer L5, the sixth layer L6, the twelfth layer L12, the fourteenth layer L14, and the fifteenth layer L15) described above with reference to FIG. 6, the fourteenth layer L14 is determined as a fusion output layer and, among the fusion receiving candidate layers L5 and L12, the fifth layer L5 is determined as a fusion receiving layer. Accordingly, the candidate execution graph CEG2c may include a fourth fused layer group FLG4c including the first layer to the fourth layer L1 to L4, a fifth fused layer group FLG5c including the fifth layer L5, the sixth layer L6, and the fourteenth layer L14, and a sixth fused layer group FLG6c including the fifteenth layer L15 and the seventh layer to the thirteenth layer L7 to L13.

With reference to FIGS. 7A and 7B, the candidate execution graphs CEG1c and CEG2c corresponding to two combinations among some of the plurality of layer fusion combinations for the operation graph OGc of FIG. 6 have been described above. The processor, according to an embodiment, may determine, as a fused execution graph, a candidate execution graph that corresponds to a minimum cost among costs of the plurality of layer fusion combinations for the operation graph OGc. For example, when the cost of the candidate execution graph CEG1c of FIG. 7A is the minimum among costs of the plurality of layer fusion combinations, the processor may perform the layer fusion on the operation graph OGc and generate a fused execution graph such as, but not limited to, the candidate execution graph CEG1c of FIG. 7A.

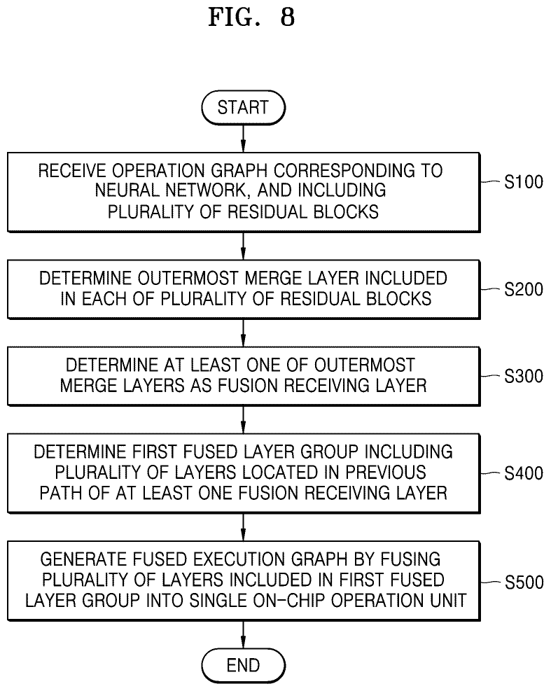

FIG. 8 is a flowchart illustrating a method of performing the layer fusion, according to an embodiment.

FIG. 8 may be understood from the description provided above with reference to FIGS. 1 to 4, 5A, 5B, 6, 7A, and 7B.

In operation S100, a processor, according to an embodiment, may receive an operation graph including a plurality of residual blocks and corresponding to a neural network.

In operation S200, the processor, according to an embodiment, may determine an outermost merge layer included in each of the plurality of residual blocks.

In operation S300, the processor, according to an embodiment, may determine at least one of the outermost merge layers among the plurality of outermost merge layers as a fusion receiving layer. However, as described above, the processor, according to an embodiment, may not determine a fusion receiving layer among the plurality of outermost merge layers. That is, a plurality of layers included in each of a plurality of split-merge blocks included in the neural network may be included in the same fused layer group.

In operation S400, the processor, according to an embodiment, may determine a first fused layer group including a plurality of layers positioned in a previous path of at least one fusion receiving layer.

In operation S500, the processor, according to an embodiment, may generate a fused execution graph by performing layer fusion on the plurality of layers included in the first fused layer group, into a single on-chip operation unit.

As described above, the processor may perform the layer fusion based on a plurality of fusion output candidate layers together with operations S100 to S500 described above. The layer fusion may be performed with reference to a fusion output candidate layer having a relatively small output feature-map size among the plurality of fusion output candidate layers, when compared to related neural networks.

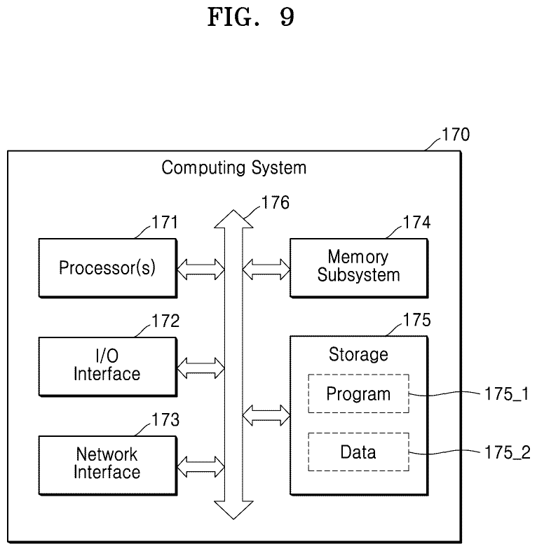

FIG. 9 is a block diagram illustrating a computing system, according to an embodiment.

In some embodiments, the method of performing layer fusion on the neural network described above with reference to the drawings may be performed by a computing system 170 of FIG. 9.

The computing system 170 may be a stationary computing system such as, but not limited to, a desktop computer, a workstation, or a server, or may be a portable computing system such as, but not limited to, a laptop computer. As illustrated in FIG. 9, the computing system 170 may include at least one processor 171, an input/output (I/O) interface 172, a network interface 173, a memory subsystem 174, a storage 175, and a bus 176. The at least one processor 171, the I/O interface 172, the network interface 173, the memory subsystem 174, and the storage 175 may communicate with each other through the bus 176.

The at least one processor 171 may be referred to as at least one processing unit and may execute a program, as a, for example, central processing unit (CPU). For example, the at least one processor 171 may access the memory subsystem 174 via the bus 176 and may execute instructions stored in the memory subsystem 174.

The at least one processor 171 may perform the layer fusion for the neural network according to the layer fusion method described above with reference to FIGS. 1 to 4, 5A, 5B, 6, 7A, 7B, and 8. The at least one processor 171, according to an embodiment, may detect candidate layers satisfying specific conditions instead of searching all the plurality of layers included in the neural network or searching a part of the neural network, and may perform layer fusion efficiently, when compared to related neural networks. The at least one processor 171, according to an embodiment, may receive an operation graph corresponding to the neural network and detect a plurality of residual blocks included in the operation graph. The residual block may include at least one merge layer. The at least one processor 171 may detect an outermost merge layer included in only one split-merge block among at least one merge layer included in the residual block. As described above, the at least one processor 171 may calculate a cost for each layer fusion combination by using outermost merge layers included in the operation graph as fusion receiving candidate layers. The at least one processor 171 may determine a layer fusion combination corresponding to a minimum cost among the costs of a plurality of layer fusion combinations. Based on the determined layer fusion combination, a fusion receiving layer may be determined among the fusion receiving candidate layers, and the layer fusion may be performed on a plurality of layers located in a previous path of the fusion receiving layer.

The at least one processor 171, according to an embodiment, may determine, as fusion output candidate layers, an input layer, one or more outermost merge layers, one or more layers located between the input layer and the initial residual block, one or more layers located between two consecutive residual blocks, and layers positioned between a final residual block and an output layer, of the operation graph. The at least one processor 171 may determine at least one fusion output layer among the fusion output candidate layers based on sizes of output feature maps of the respective fusion output candidate layers. For example, a fusion output candidate layer that outputs an output feature map having a relatively small size based on the threshold ratio or threshold described above may be determined as a fusion output layer. The at least one processor 171, according to an embodiment, may perform the layer fusion on the at least one fusion output layer and a subsequent layer located on a next path of the fusion output layer.

The at least one processor 171, according to an embodiment, may find a layer fusion combination having the lowest cost by considering both the fusion receiving candidate layers and the fusion output candidate layers described above. For example, the at least one processor 171 may find a minimum cost for the operation graph by the dynamic programming scheme reusing costs for partial graphs, and may generate a fused execution graph by performing the layer fusion on the operation graph based on a combination of the fusion receiving candidate layers and the fusion output candidate layers corresponding thereto.

The I/O interface 172 may include input devices such as, but not limited to, a keyboard and a pointing device and/or output device such as, but not limited to, a display device and a printer, or may provide access to the input and/or output devices. A user may trigger execution of a program 175_1 and/or loading of data 175_2 via the I/O interface 172. The program 175_1 may be configured to perform the layer fusion method described above and generated by a compiler.

The network interface 173 may provide access to a network external to the computing system 170. For example, the network may include a plurality of computing systems and communication links, and the communication links may include, but not be limited to, wired links, optical links, wireless links, or any other form of links.

The memory subsystem 174 may store the program 175_1 or at least a portion thereof for the neural network layer fusion method described above with reference to the drawings, and the at least one processor 171 may perform at least a part of the operations included in the neural network layer fusion method by executing the program (or instructions) stored in the memory subsystem 174. The memory subsystem 174 may include read only memory (ROM), random access memory (RAM), or the like.

The storage 175 may be and/or may include a non-transitory storage medium, and may not lose stored data even when power supplied to the computing system 170 is cut off For example, the storage 175 may include a non-volatile memory device, and may include a storage medium such as, but not limited to, a magnetic tape, an optical disk, or a magnetic disk. In addition, the storage 175 may be detachable from the computing system 170.

As illustrated in FIG. 9, the storage 175 may store the program 175_1 and the data 175_2. Before being executed by the at least one processor 171, at least a part of the program 175_1 may be loaded into the memory subsystem 174. In some embodiments, the storage 175 may store a file written in a programming language, and the program 175_1 or at least a portion thereof generated from the file by a compiler or the like may be loaded into the memory subsystem 174. The at least one processor 171 may perform at least a part of the layer fusion method for the neural network described above with reference to the drawings by executing the program 175_1. The data 175_2 may include data required to perform the layer fusion method for the neural network described above with reference to the drawings. In addition, the data 175_2 may include data generated by performing the layer fusion method for the neural network described above with reference to the drawings, for example, the global-output feature map G-OFM of FIG. 1.

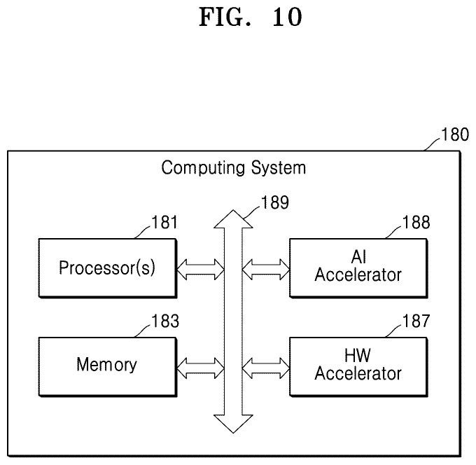

FIG. 10 is a block diagram illustrating a computing system, according to an embodiment.

In some embodiments, the method for the neural network layer fusion, according to an embodiment, may be executed on a computing system 180.

Referring to FIG. 10, the computing system 180 may include at least one processor 181, a memory 183, an artificial intelligence (AI) accelerator 185, and a hardware accelerator 187. The at least one processor 181, the memory 183, the AI accelerator 185, and the hardware accelerator 187 may communicate with each other via a bus 189. In some embodiments, the at least one processor 181, the memory 183, the AI accelerator 185, and the hardware accelerator 187 may be included in a single semiconductor chip. In addition, in some embodiments, at least two of the at least one processor 181, the memory 183, the AI accelerator 185, and the hardware accelerator 187 may be respectively included in two (2) or more semiconductor chips mounted on a board.

The at least one processor 181 may execute instructions. For example, the at least one processor 181 may execute an operating system by executing instructions stored in the memory 183, and may also execute applications running on the operating system. In some embodiments, the at least one processor 181 may instruct the AI accelerator 185 and/or the hardware accelerator 187 to perform tasks by executing instructions, and may obtain task execution results from the AI accelerator 185 and/or the hardware accelerator 187. In some embodiments, the at least one processor 181 may be an application specific instruction set processor (ASIP) customized for a specific purpose, and may support a dedicated instruction set. In some embodiments, the at least one processor 181 may perform the layer fusion on a neural network executed by the AI accelerator 188.

The memory 183 may have any structure for storing data. For example, the memory 183 may include volatile memory devices such as, but not limited to, DRAM and SRAM, and/or may include non-volatile memory devices such as, but not limited to, flash memory and RRAM. The at least one processor 181, the AI accelerator 185, and the hardware accelerator 187 may store data in and/or read data from the memory 183 via the bus 189.

The at least one processor 181 and the memory 183, according to an embodiment, may be understood with reference to the above descriptions, and particularly with reference to the descriptions of the at least one processor 171 and the storage 175 of FIG. 9, and may include additional features not mentioned above. Consequently, repeated descriptions of the at least one processor 181 and the memory 183 described above with reference to FIG. 9 may be omitted for the sake of brevity.

The AI accelerator 185 may refer to hardware designed for AI applications. In some embodiments, the AI accelerator 185 may include an NPU for implementing a neuromorphic structure, may generate output data by processing input data provided from the at least one processor 181 and/or the hardware accelerator 187, and may provide the output data to the at least one processor 181 and/or the hardware accelerator 187. In some embodiments, the AI accelerator 185 may be programmable and may be programmed by the at least one processor 181 and/or the hardware accelerator 187.

The hardware accelerator 187 may refer to hardware designed to perform specific tasks at high speed. For example, the hardware accelerator 187 may be designed to perform data conversions such as, but not limited to, demodulation, modulation, encoding, and decoding at high speed. The hardware accelerator 187 may be programmable and may be programmed by the at least one processor 181 and/or the hardware accelerator 187.

While the present disclosure has been particularly shown and described with reference to embodiments thereof, it is to be understood that various changes in form and details may be made therein without departing from the spirit and scope of the following claims.

What is claimed is:

1. A method of performing layer fusion on a plurality of layers comprised in a neural network for execution on hardware, the method comprising:
receiving an operation graph comprising a plurality of residual blocks and corresponding to the neural network;
determining an outermost merge layer comprised in each of the plurality of residual blocks;
determining at least one fusion receiving layer from among a plurality of outermost merge layers of the plurality of residual blocks;
determining a first fused layer group comprising a plurality of fused layers positioned in a previous path of the at least one fusion receiving layer; and
generating a fused execution graph corresponding to a first single on-chip operation unit by performing the layer fusion on the plurality of fused layers.

2. The method of claim 1, wherein the outermost merge layer is included in a single split-merge block from among the plurality of residual blocks.

3. The method of claim 1, wherein the determining the at least one fusion receiving layer comprises:
obtaining a cost for each of a plurality of layer fusion combinations of the operation graph, based on combinations of the plurality of outermost merge layers; and
determining the at least one fusion receiving layer based on a layer fusion combination corresponding to a minimum cost from among a plurality of costs corresponding to the plurality of layer fusion combinations.

4. The method of claim 3, wherein the obtaining the cost comprises:
obtaining, for each of the plurality of layer fusion combinations, a cost sum of each of a plurality of partial graphs comprised in the operation graph corresponding to each of the plurality of layer fusion combinations.

5. The method of claim 4, wherein the cost of a layer fusion combination of the plurality of layer fusion combinations corresponds to an elapsed time from a time at which a first input feature map of the neural network is loaded to a time at which a final output feature map is stored in an off-chip memory, based on the layer fusion combination of the plurality of layer fusion combinations.

6. The method of claim 1, further comprising:
determining a plurality of fusion output candidate layers comprising an input layer of the neural network, the plurality of outermost merge layers, a layer positioned between the input layer and an initial residual block, a layer positioned between two adjacent residual blocks, and a layer positioned between a final residual block and an output layer of the neural network;
determining, as at least one fusion output layer, at least one fusion output candidate layer from among the plurality of fusion output candidate layers; and
determining at least one second fused layer group comprising the at least one fusion output layer and at least one layer positioned in a previous path of the at least one fusion output layer,
wherein the generating the fused execution graph comprises generating the fused execution graph by further performing the layer fusion, in a second single on-chip operation unit, on the at least one fusion output layer and the at least one layer comprised in the at least one second fused layer group.

7. The method of claim 6, wherein the determining the at least one fusion output candidate layer comprises:
determining, based on a size of an output feature map of each of the plurality of fusion output candidate layers, the at least one fusion output candidate layer, from among the plurality of fusion output candidate layers, as the at least one fusion output layer.

8. The method of claim 7, wherein the determining the at least one fusion output candidate layer comprises:
determining, as the at least one fusion output layer, the at least one fusion output candidate layer having a minimum size of the size of the output feature map from among the plurality of fusion output candidate layers,
wherein a ratio of a number of the at least one fusion output layer to a number of the plurality of fusion output candidate layers is less than or equal to a preset threshold ratio.

9. The method of claim 7, wherein the determining the at least one fusion output candidate layer comprises:
determining, as the at least one fusion output layer, the at least one fusion output candidate layer having the size of the output feature map less than or equal to a preset threshold, from among the plurality of fusion output candidate layers.

10. A method of performing layer fusion on a plurality of layers comprised in a neural network for execution on hardware, the method comprising:
receiving an operation graph comprising a plurality of residual blocks and corresponding to the neural network;
determining a plurality of fusion output candidate layers comprising an input layer of the operation graph, an outermost merge layer comprised in each of the plurality of residual blocks, a layer positioned between the input layer and an initial residual block, a layer positioned between two adjacent residual blocks, and a layer positioned between a final residual block and an output layer of the neural network;
determining, as at least one fusion output layer, at least one fusion output candidate layer from among the plurality of fusion output candidate layers;
determining at least one first fused layer group that comprises the at least one fusion output layer and at least one layer positioned in a previous path of the at least one fusion output layer; and
generating a fused execution graph corresponding to a first single on-chip operation unit by performing the layer fusion on layers comprised in the at least one first fused layer group.

11. The method of claim 10, wherein the determining the at least one fusion output candidate layer comprises:
determining, based on a size of an output feature map of each of the plurality of fusion output candidate layers, the at least one fusion output candidate layer as the at least one fusion output layer.

12. The method of claim 11, wherein the determining the at least one fusion output candidate layer comprises:
determining, as the at least one fusion output layer, the at least one fusion output candidate layer having a minimum size of the size of the output feature map from among the plurality of fusion output candidate layers, as the at least one fusion output layer,
wherein a ratio of a number of the at least one fusion output layer to a number of the plurality of fusion output candidate layers is less than or equal to a preset threshold ratio.

13. The method of claim 11, wherein the determining the at least one fusion output candidate layer comprises:
determining, as the at least one fusion output layer, the at least one fusion output candidate layer having the size of the output feature map less than or equal to a preset threshold, from among the plurality of fusion output candidate layers.

14. The method of claim 10, further comprising:
determining, as at least one fusion receiving layer, at least one outermost merge layer from among a plurality of outermost merge layers comprised in each of the plurality of residual blocks; and
determining a second fused layer group comprising a plurality of layers positioned in a previous path of the at least one fusion receiving layer,
wherein the generating the fused execution graph comprises:
generating the fused execution graph by further performing the layer fusion on layers comprised in the second fused layer group, into a second single on-chip operation unit.

15. The method of claim 14, wherein the outermost merge layer is comprised in a single split-merge block from among the plurality of residual blocks.

16. The method of claim 14, wherein the determining of the at least one fusion receiving layer comprises:
obtaining a cost for each of a plurality of layer fusion combinations of the operation graph based on combinations of the plurality of outermost merge layers; and
determining the at least one fusion receiving layer based on a layer fusion combination corresponding to a minimum cost from among a plurality of costs corresponding to the plurality of layer fusion combinations.

17. The method of claim 16, wherein the obtaining the cost comprises:
obtaining, for each of the plurality of layer fusion combinations, a sum of costs of a plurality of partial graphs comprised in the operation graph corresponding to each of the plurality of layer fusion combinations.

18. The method of claim 17, wherein the cost of a layer fusion combination of the plurality of layer fusion combinations corresponds to an elapsed time from a time at which a first input feature map of the neural network is loaded to a time at which a final output feature map is stored in an off-chip memory based on the layer fusion combination of the plurality of layer fusion combinations.

19. An apparatus for performing layer fusion on a plurality of layers comprised in a neural network, comprising:
memory storing instructions;
one or more processors comprising processing circuitry,
wherein the instructions, when executed by the one or more processors individually or collectively, cause the apparatus to:
receive an operation graph corresponding to the neural network;
detect, as a plurality of fusion receiving candidate layers, outermost merge layers comprised in each of a plurality of residual blocks comprised in the operation graph;
detect a plurality of fusion output candidate layers positioned between two consecutive residual blocks of the plurality of residual blocks;
obtain a cost for each of a plurality of layer fusion combinations corresponding to combinations of the plurality of fusion receiving candidate layers and the plurality of fusion output candidate layers; and
generate a fused execution graph by performing layer fusion on the operation graph based on a layer fusion combination corresponding to a minimum cost from among the plurality of layer fusion combinations,
wherein a size of an output feature map of at least one fusion output candidate layer based on the layer fusion combination corresponding to the minimum cost is less than or equal to a bottom 25% from among sizes of output feature maps of the plurality of fusion output candidate layers.

20. The apparatus of claim 19, wherein the instructions, when executed by the one or more processors individually or collectively, cause the apparatus to:
obtain a cost of at least one partial graph comprised in the operation graph corresponding to each of the plurality of layer fusion combinations; and
obtain the cost for each of the plurality of layer fusion combinations based on a sum of costs of the at least one partial graph.
